(19) United States
(12) Patent Application Publication
(10) Pub. No.: US 2026/0225608 A1
(43) Pub. Date: Aug. 6, 2026

(54) SYSTEMS AND METHODS FOR MANAGING ADVANCED SENSING VEHICLE SERVICE NETWORKS

(71) Applicant: GM GLOBAL TECHNOLOGY OPERATIONS LLC, Detroit, MI (US)

(72) Inventors: Donald K. Grimm, Utica, MI (US); Fan Bai, Ann Arbor, MI (US); Michael Wahlstrom, Wolverine Lake, MI (US); Paul E. Krajewski, Troy, MI (US)

(73) Assignee: GM GLOBAL TECHNOLOGY OPERATIONS LLC, Detroit, MI (US)

(21) Appl. No.: 19/045,675

(22) Filed: Feb. 5, 2025

(51) Int. Cl. B60W 60/00; H04W 4/46; H04W 64/00

(52) U.S. Cl. CPC B60W 60/001; H04W 4/46; H04W 64/00; B60W 2556/45

(57) ABSTRACT

An advanced sensing vehicle (ASV) service request including a basic sensing vehicle (BSV) location is received from a BSV. At least one formation ASV is identified from a list of ASVs within a pre-defined distance of the BSV operating below an ASV capacity to provide ASV services to the BSV. An automation system level of each formation ASV is higher than an automation system level of the BSV. An ASV service instruction including an ASV formation position is transmitted to each formation ASV. An ASV service network configuration is formed with respect to the BSV when each formation ASV moves to the ASV formation position received in the associated ASV service instruction. Each formation ASV establishes a communication channel with the BSV and transmits ASV sensor data to the BSV for use by an Advanced Driving System (ADS) of the BSV to implement ADS operations.

### INTRODUCTION

The technical field generally relates to vehicle networks, and more particularly relates to systems and methods for managing advanced sensing vehicle service networks.

Different vehicles have various levels of automation. Examples of the various levels of automation are Level Two, Level Three, Level Four and Level Five automation. Level two automation means the vehicle assists a driver in various driving tasks with driver supervision. Level three automation means the vehicle can take over all driving functions under certain circumstances. All major functions are automated, including braking, steering, and acceleration. At this level, the driver can fully disengage until the vehicle tells the driver otherwise. A Level Four system indicates “high automation”, referring to a driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

An advanced sensing vehicle (ASV) has a higher level of automation compared to a basic sensing vehicle (BSV) and includes instrumentation that is able to generate sensor data that BSV instrumentation is unable to detect and/or generate.

Accordingly, it is desirable to provide systems and methods for managing advance sensing vehicle service networks. Other desirable features and characteristics will become apparent from the subsequent detailed description and the appended claims, taken in conjunction with the accompanying drawings and the foregoing technical field and background.

### SUMMARY

A method of managing an advance sensing vehicle (ASV) service network includes: receiving, by a controller, an ASV service request from a basic sensing vehicle (BSV), the ASV service request comprising a BSV location; identifying, by the controller, at least one formation ASV from a list of ASVs within a pre-defined distance of the BSV operating below an ASV capacity to provide ASV services to the BSV, wherein the list of ASVs is maintained at the controller and a level of an automation system of each of the at least one formation ASVs is higher than a level of an automation system of the BSV; and transmitting, by the controller, an ASV service instruction comprising an ASV formation position to each of the at least one formation ASV, wherein: a ASV service network configuration is formed with respect to the BSV when each of the at least one formation ASV moves to the ASV formation position received in the associated ASV service instruction, each of the at least one formation ASV establishes a communication channel with the BSV, and each of the at least one formation ASV transmits ASV sensor data to the BSV for use by an Advanced Driving System (ADS) of the BSV to implement ADS operations.

In at least one embodiment, the method further includes receiving, by the controller, the ASV service request from the BSV, wherein the ASV service request is automatically generated by the BSV in response to the BSV entering an ASV service area.

In at least one embodiment, the method further includes receiving, by the controller, the ASV service request from the BSV, wherein the ASV service request is generated by the BSV in response to activation of a ASV service request button of the BSV.

In at least one embodiment, the method further includes receiving, by the controller, the ASV service request from the BSV, wherein the ASV service request is automatically generated by the BSV in response to activation of at least one specific function of the BSV.

In at least one embodiment, the method further includes defining, by the controller, a coverage area associated with the ASV service network configuration; partitioning, by the controller, the coverage area into a plurality of partitioned areas using Voronoi partitioning, each of the plurality of partitioned areas in including a centroid; and transmitting, by the controller, the ASV service instruction comprising the ASV formation position to each of the at least one formation ASV, wherein each ASV formation position is based on the centroid of one of the plurality of partitioned areas.

In at least one embodiment, the method further includes defining, by the controller, a coverage area associated with the ASV service network configuration; partitioning, by the controller, the coverage area into a plurality of partitioned areas using grid-based partitioning, each of the plurality of partitioned areas in including a center; and transmitting, by the controller, the ASV service instruction comprising the ASV formation position to each of the at least one formation ASV, wherein each ASV formation position comprises the center of a partitioned grid.

In at least one embodiment, the ASV service network configuration is a full-forward ASV service network configuration.

In at least one embodiment, the ASV service network configuration is a distributed ASV service network configuration.

In at least one embodiment, the ASV service network configuration is a dispersed ASV service network configuration.

In at least one embodiment, the ASV sensor data includes perception data, driving behavior events, network data, and services data.

In at least one embodiment, the method further includes receiving, at the controller, BSV data from the BSV, the BSV data comprising Global Positioning System (GPS) time, latitude, longitude, speed, yaw, and acceleration; generating, by the controller, a predicted BSV path based on the BSV data; generating, by the controller, a predicted next BSV location based on the predicted BSV path; generating updated ASV formation positions for each of the at least one formation ASVs based on the predicted next BSV location, the updated ASV formation positions being associated with a dynamic reconfiguration of the ASV service network configuration to accommodate the predicted next BSV location; and transmitting the updated ASV formation positions to each of the at least one formation ASVs.

An advanced sensing vehicle (ASV) network management system includes at least one processor and at least one memory communicatively coupled to the at least one processor. The at least one memory includes instructions that upon execution by the at least one processor, causes the at least one processor to: receive an ASV service request from a basic sensing vehicle (BSV), the ASV service request comprising a BSV location; identify at least one formation ASV from a list of ASVs within a pre-defined distance of the BSV operating below an ASV capacity to provide ASV services to the BSV, wherein the list of ASVs is maintained at the controller and a level of an automation system of each of the at least one formation ASVs is higher than a level of an automation system of the BSV; and transmit an ASV service instruction comprising an ASV formation position to each of the at least one formation ASV, wherein: a ASV service network configuration is formed with respect to the BSV when each of the at least one formation ASV moves to the ASV formation position received in the associated ASV service instruction, each of the at least one formation ASV establishes a communication channel with the BSV, and each of the at least one formation ASV transmits ASV sensor data to the BSV for use by an Advanced Driving System (ADS) of the BSV to implement ADS operations.

In at least one embodiment, the at least one memory further includes instructions that upon execution by the at least one processor, causes the at least one processor to: define a coverage area associated with the ASV service network configuration; partition the coverage area into a plurality of partitioned areas using Voronoi partitioning, each of the plurality of partitioned areas in including a centroid; and transmit the ASV service instruction comprising the ASV formation position to each of the at least one formation ASV, wherein each ASV formation position is based on the centroid of one of the plurality of partitioned areas.

In at least one embodiment, the at least one memory further includes instructions that upon execution by the at least one processor, causes the at least one processor to: define a coverage area associated with the ASV service network configuration; partition the coverage area into a plurality of partitioned areas using grid-based partitioning, each of the plurality of partitioned areas in including a center; and transmit the ASV service instruction comprising the ASV formation position to each of the at least one formation ASV, wherein each ASV formation position comprises the center of a partitioned grid.

In at least one embodiment, the ASV service network configuration is a full-forward ASV service network configuration.

In at least one embodiment, the ASV service network configuration is a distributed ASV service network configuration.

In at least one embodiment, the ASV service network configuration is a dispersed ASV service network configuration.

In at least one embodiment, the ASV sensor data includes perception data, driving behavior events, network data, and services data.

In at least one embodiment, the at least one memory further includes instructions that upon execution by the at least one processor, causes the at least one processor to: receive BSV data from the BSV, the BSV data comprising Global Positioning System (GPS) time, latitude, longitude, speed, yaw, and acceleration; generate a predicted BSV path based on the BSV data; generate a predicted next BSV location based on the predicted BSV path; generate updated ASV formation positions for each of the at least one formation ASVs based on the predicted next BSV location, the updated ASV formation positions being associated with a dynamic reconfiguration of the ASV service network configuration to accommodate the predicted next BSV location; and transmit the updated ASV formation positions to each of the at least one formation ASVs.

A cloud based service system including an advanced sensing vehicle (ASV) network management system includes at least one processor and at least one memory communicatively coupled to the at least one processor. The at least one memory includes instructions that upon execution by the at least one processor, causes the at least one processor to: receive an ASV service request from a basic sensing vehicle (BSV), the ASV service request comprising a BSV location; identify at least one formation ASV from a list of ASVs within a pre-defined distance of the BSV operating below an ASV capacity to provide ASV services to the BSV, wherein the list of ASVs is maintained at the controller and a level of an automation system of each of the at least one formation ASVs is higher than a level of an automation system of the BSV; define a coverage area associated with an ASV service network configuration; partition the coverage area into a plurality of partitioned areas using Voronoi partitioning, each of the plurality of partitioned areas in including a centroid; and transmit an ASV service instruction comprising an ASV formation position to each of the at least one formation ASV, each ASV formation position being based on the centroid of one of the plurality of partitioned areas, wherein: the ASV service network configuration is formed with respect to the BSV when each of the at least one formation ASV moves to the ASV formation position received in the associated ASV service instruction, each of the at least one formation ASV establishes a communication channel with the BSV, and each of the at least one formation ASV transmits ASV sensor data to the BSV for use by an Advanced Driving System (ADS) of the BSV to implement ADS operations.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram of a vehicle that is configured to be an advanced sensing vehicle (ASV) in accordance with at least one embodiment;

FIG. 2 is a functional block diagram of a cloud-based service system including an ASV service network management system in accordance with at least one embodiment;

FIG. 3 is a flowchart representation of an exemplary method of managing an ASV service network in accordance with at least one embodiment;

FIG. 4 is an exemplary diagram of a full-forward ASV service network configuration in accordance with at least one embodiment;

FIG. 5 is an exemplary diagram of a distributed ASV service network configuration in accordance with at least one embodiment;

FIG. 6 is an exemplary diagram of a dispersed ASV service network configuration in accordance with at least one embodiment;

FIG. 7 is an exemplary diagram of a plurality of ASV formation positions based on Voronoi partitioning in accordance with at least one embodiment; and

FIG. 8 is an exemplary diagram of a plurality of ASV formation positions based on grid-based partitioning in accordance with at least one embodiment.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

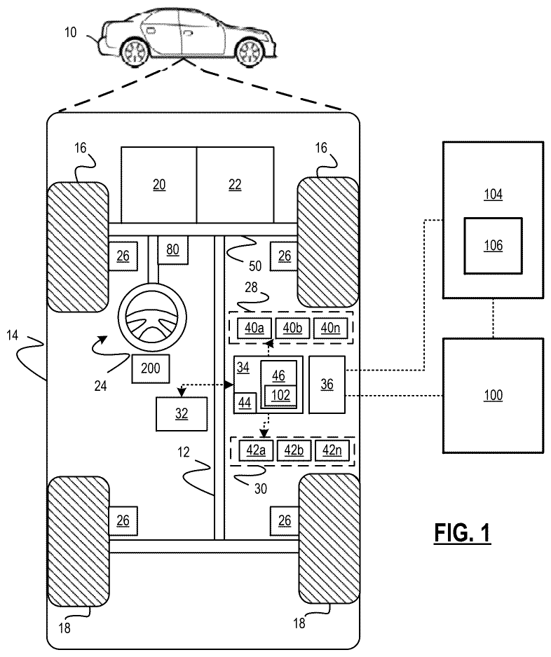

Referring to FIG. 1, a functional block diagram of a vehicle 10 configured to be communicatively coupled to an advanced sensing vehicle (ASV) service network management system 100 in accordance with at least one embodiment is shown. The vehicle 10 is configured to be an ASV. The ASV includes an ASV system 102. The ASV system 102 is configured to be communicatively coupled to the ASV service network management system 100. The ASV service network management system 100 is configured to be communicatively coupled to a basic sensing vehicle (BSV) 104. The BSV 104 includes a BSV system 106. The BSV system 106 is configured to be communicatively coupled to the ASV service network management system 100. The ASV system 102 is configured to be communicatively coupled to the BSV system 106. The BSV 104 has a configuration similar to the vehicle 10. The BSV 104 has lower level automation system than the ASV. The automation system levels are described in greater detail below.

While the ASV service network management system 100 is shown as being communicatively coupled to a single ASV and a single BSV 104, the ASV service network management system 100 is configured to be communicatively coupled to multiple ASVs and multiple BSVs 104 at the same time. While the BSV 104 is shown as being communicative coupled to single ASV, the BSV 104 may be communicatively coupled to multiple ASVs. While the ASV is shown as being communicative coupled to single BSV 104, the ASV may be communicatively coupled to multiple BSVs 104.

The vehicle 10 generally includes a chassis 12, a body 14, front wheels 16, and rear wheels 18. While the vehicle 10 is depicted in the illustrated embodiment as a passenger car, the vehicle 10 may be other types of vehicles including trucks, sport utility vehicles (SUVs), and recreational vehicles (RVs).

In various embodiments, the body 14 is arranged on the chassis 12 and substantially encloses components of the vehicle 10. The body 14 and the chassis 12 may jointly form a frame. The wheels 16, 18 are each rotationally coupled to the chassis 12 near a respective corner of the body 14.

In various embodiments, the vehicle 10 is an autonomous or semi-autonomous vehicle that is automatically controlled to carry passengers and/or cargo from one place to another. For example, in an exemplary embodiment, the vehicle 10 is a so-called Level Two, Level Three, Level Four or Level Five automation system. Level two automation means the vehicle assists the driver in various driving tasks with driver supervision. Level three automation means the vehicle can take over all driving functions under certain circumstances. All major functions are automated, including braking, steering, and acceleration. At this level, the driver can fully disengage until the vehicle tells the driver otherwise. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

As shown, the vehicle 10 generally includes a propulsion system 20 a transmission system 22, a steering system 24, a braking system 26, a sensor system 28, an actuator system 30, at least one data storage device 32, at least one controller 34, and a communication system 36. The controller 34 is configured to implement an automated driving system (ADS). The propulsion system 20 is configured to generate power to propel the vehicle. The propulsion system 20 includes an internal combustion engine (ICE). The propulsion system 20 may, in various embodiments, also include an electric machine such as a traction motor, a fuel cell propulsion system, and/or any other type of propulsion configuration. The transmission system 22 is configured to transmit power from the propulsion system 20 to the vehicle wheels 16, 18 according to selectable speed ratios. According to various embodiments, the transmission system 22 may include a step-ratio automatic transmission, a continuously-variable transmission, or other appropriate transmission. The braking system 26 is configured to provide braking torque to the vehicle wheels 16, 18. The braking system 26 may, in various embodiments, include friction brakes, brake by wire, a regenerative braking system such as an electric machine, and/or other appropriate braking systems.

The steering system 24 is configured to influence a position of the of the vehicle wheels 16. While depicted as including a steering wheel and steering column, for illustrative purposes, in some embodiments contemplated within the scope of the present disclosure, the steering system 24 may not include a steering wheel and/or steering column. The steering system 24 includes a steering column coupled to an axle 50 associated with the front wheels 16 through, for example, a rack and pinion or other mechanism (not shown). Alternatively, the steering system 24 may include a steer by wire system that includes actuators associated with each of the front wheels 16.

The sensor system 28 includes one or more sensing devices 40a-40n that sense observable conditions of the exterior environment and/or the interior environment of the vehicle 10. The sensing devices 40a-40n can include, but are not limited to, radars, lidars, global positioning systems, optical cameras, thermal cameras, ultrasonic sensors, a steering wheel sensor, and/or other sensors.

The vehicle dynamics sensors provide vehicle dynamics data including longitudinal speed, yaw rate, lateral acceleration, longitudinal acceleration, etc. The vehicle dynamics sensors may include wheel sensors that measure information pertaining to one or more wheels of the vehicle 10. In one embodiment, the wheel sensors comprise wheel speed sensors that are coupled to each of the wheels 16, 18 of the vehicle 10. Further, the vehicle dynamics sensors may include one or more accelerometers (provided as part of an Inertial Measurement Unit (IMU)) that measure information pertaining to an acceleration of the vehicle 10. In various embodiments, the accelerometers measure one or more acceleration values for the vehicle 10, including latitudinal and longitudinal acceleration and yaw rate. In at least one embodiment, the vehicle dynamic sensors provide vehicle location and vehicle movement data.

The actuator system 30 includes one or more actuator devices 42a-42n that control one or more vehicle features such as, but not limited to, one or more vehicle wheels 16, 18 the propulsion system 20, the transmission system 22, the steering system 24, and the braking system 26. In various embodiments, the vehicle features can further include interior and/or exterior vehicle features such as, but are not limited to, doors, a trunk, and cabin features such as air, music, lighting, etc. (not numbered).

The communication system 36 is configured to wirelessly communicate information to and from other entities 48, such as but not limited to, other vehicles (vehicle to vehicle, “V2V” communication,) infrastructure (vehicle to infrastructure “V2I” communication), remote systems, and/or personal devices. In an exemplary embodiment, the communication system 36 is a wireless communication system configured to communicate via a wireless local area network (WLAN) using IEEE 802.11 standards or by using cellular data communication. However, additional, or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The data storage device 32 stores data for use in the ADS of the vehicle 10. In various embodiments, the data storage device 32 stores defined maps of the navigable environment. In various embodiments, the defined maps may be predefined by and obtained from a remote system. For example, the defined maps may be assembled by the remote system and communicated to the vehicle 10 (wirelessly and/or in a wired manner) and stored in the data storage device 32. As can be appreciated, the data storage device 32 may be part of the controller 34, separate from the controller 34, or part of the controller 34 and part of a separate system.

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor-based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the vehicle 10, and generate control signals to the actuator system 30 to automatically control the components of the vehicle 10 based on the logic, calculations, methods, and/or algorithms. Although only one controller 34 is shown in FIG. 1, embodiments of the vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the vehicle 10. In various embodiments, the controller(s) 34 are configured to implement ADS.

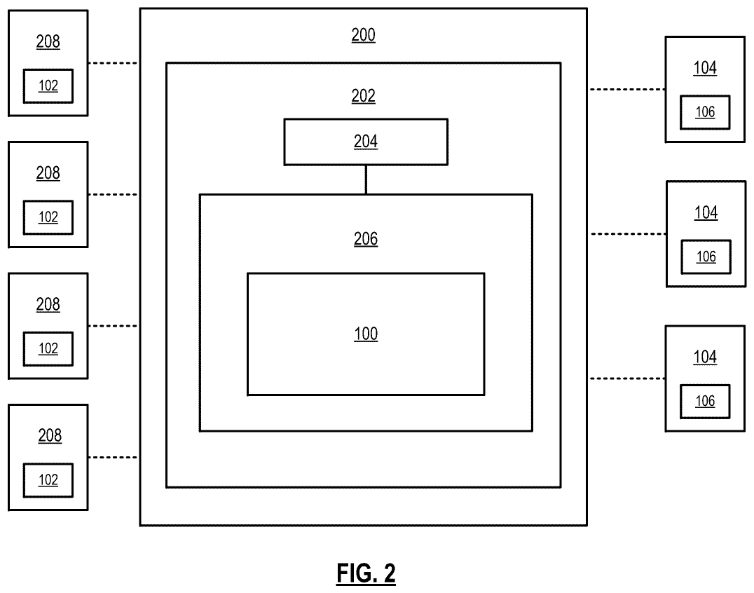

Referring to FIG. 2, a functional block diagram of a cloud-based service system 200 including an ASV service network management system 100 in accordance with at least one embodiment is shown. The cloud-based service system 200 includes at least one controller 202. The controller(s) 202 includes at least one processor 204 and at least one memory 206. The at least one processor 204 is a programable device that includes one or more instructions stored in or associated with the at least one memory 206. The at least one memory 206 includes instructions that the at least one processor 204 is configured to execute. The at least one memory 206 includes an embodiment of the ASV service network management system 100.

The ASV service network management system 100 is configured to be communicatively coupled a plurality of ASVs 208. Each ASV 208 includes an ASV system 102. The ASV service network management system 100 is configured to be communicatively coupled to the plurality of ASVs 208 via the associated ASV system 102. The ASV service network management system 100 is configured to be communicatively coupled a plurality of BSVs 104. Each BSV 104 includes a BSV system 106. The ASV service network management system 100 is configured to be communicatively coupled to the plurality of BSVs 104 via the associated BSV system 106.

Each ASV 208 is configured to be communicatively coupled to one or more BSVs 104. In at least one embodiment, each ASV systems 102 is configured to be communicatively coupled to one or more BSV systems 106. Each BSV 104 is configured to be communicatively coupled to one or more ASVs 208. In at least one embodiment, each BSV system 106 is configured to be communicatively coupled to one or more ASV systems 102.

The cloud-based service system 200 may include additional components that facilitate operation of the ASV service network management system 100. The operation of the ASV service network management system 100 will be described in greater detail below.

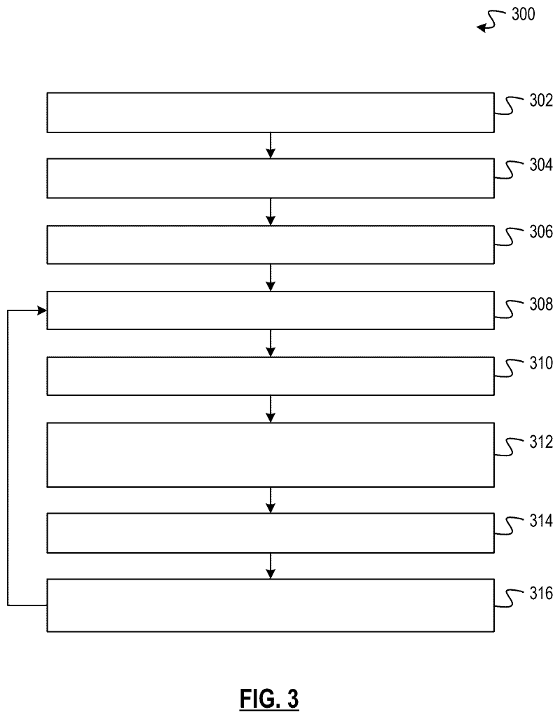

Referring to FIG. 3, a flowchart representation of an exemplary method 300 of managing an ASV service network in accordance with at least one embodiment is shown. The method 300 will be described with reference to an exemplary implementation of an embodiment of a ASV service network management system 100. As can be appreciated in light of the disclosure, the order of operation within the method 300 is not limited to the sequential execution as illustrated in FIG. 3 but may be performed in one or more varying orders as applicable and in accordance with the present disclosure.

At 302, an ASV service request is received from a BSV 104 at the ASV service network management system 100. The ASV service request is received from a BSV system 106 of the BSV 104 at the ASV service network management system 100. The ASV service request includes a BSV identifier and a BSV location of the BSV 104. The BSV location is a real time location of the BSV 104.

In at least one embodiment, a user of the BSV 104 is provided with an option to enable an automatic transmission of the ASV service request from the BSV system 106 to the ASV service network management system 100 when the BSV 104 enters an ASV service area. The BSV system 106 receives BSV locations from a sensor system 28 of the BSV 104. The BSV system 106 is configured to store ASV service areas. Upon a determination by the BSV system 106 that the BSV 104 has entered an ASV service area based on a received BSV location, the BSV system 106 automatically generates the ASV service request for transmission from the BSV 104 to the ASV service network management system 100.

In at least one embodiment, the BSV 104 includes an ASV service request button that is communicatively coupled to the BSV system 106. Upon activation of the ASV service request button by a user of the BSV 104, the BSV system 106 automatically generates the ASV service request for transmission from the BSV 104 to the ASV service network management system 100.

In at least one embodiment, a user of the BSV 104 is provided with an option to enable the automatic transmission of the ASV service request from the BSV 104 to the ASV service network management system 100 when one or more specific functions of the BSV 104 is activated. An example of a specific function is an automated cruising driver assistance function that allows for hands-free driving on certain roads. It uses sensors, cameras, GPS, and LiDAR to help the vehicle 10 stay in its lane and to maintain a safe following distance from the vehicle in front. Upon a determination by the BSV system 106 that at least one of the specific functions has been activated at the BSV 104, the BSV system 106 automatically generates the ASV service request for transmission from the BSV 104 to the ASV service network management system 100.

At 304, the ASV service network management system 100 identifies a set of formation ASVs 208 to form an ASV service network with respect to the BSV 104. The ASV service network management system 100 maintains a list of ASVs 208. The ASV service network management system 100 identifies the ASVs 208 within a pre-defined distance of the BSV location received in the ASV service request from the BSV 104. An example of a pre-defined distance is 200 meters.

The ASV service network management system 100 identifies the ASVs 208 within the pre-defined distance of the BSV location of the BSV 104 with an ASV capacity to provide ASV services to the BSV 104. The ASV capacity of an ASV 208 is a maximum number of BSVs 104 that the ASV 208 can provide ASV services to at one time. The ASV service network management system 100 identifies the ASVs 208 within the pre-defined distance of the BSV 104 that are operating below the associated ASV capacity to form the set of formation ASVs 208.

At 306, the ASV service network management system 100 transmits a ASV service instruction to each of the formation ASVs 208 to form an ASV service network configuration with respect to the BSV 104. The ASV service instruction to each ASV 208 includes an ASV formation position for that ASV 208 within the ASV service network configuration. The ASV service network management system 100 identifies the ASV service network configuration based on the nature of the ASV services provided to the BSV 104.

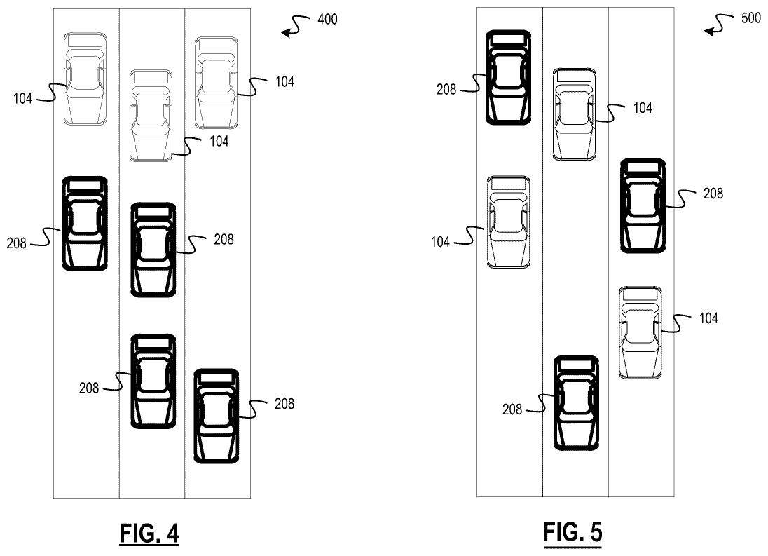

When the ASV services provided to the BSV 104 address forward lane scanning, the ASV service network management system 100 selects a full-forward ASV service network configuration. Referring to FIG. 4, an exemplary diagram of a full-forward ASV service network configuration 400 in accordance with at least one embodiment is shown. The formation ASVs 208 are disposed in the full-forward ASV network service configuration 400 to provide forward lane scanning ASV services to multiple BSVs 104.

When the ASV services provided to the BSV 104 address timely event detection, coverage, and response, the ASV service network management system 100 selects a distributed ASV service network configuration. Referring to FIG. 5, an exemplary diagram of a distributed ASV service network configuration 500 in accordance with at least one embodiment is shown. The formation ASVs 208 are disposed in the distributed ASV service network configuration 500 to provide timely event detection, coverage, and response ASV services to multiple BSVs 104. The formation ASVs 208 are distributed uniformly to provide comprehensive coverage. Each formation ASV 208 covers a different region of road network or traffic environment, ensuring no overlapping or clustering in one area. The distributed ASV service network configuration 500 enables lane hazard detection and anomalous driving behavior detection.

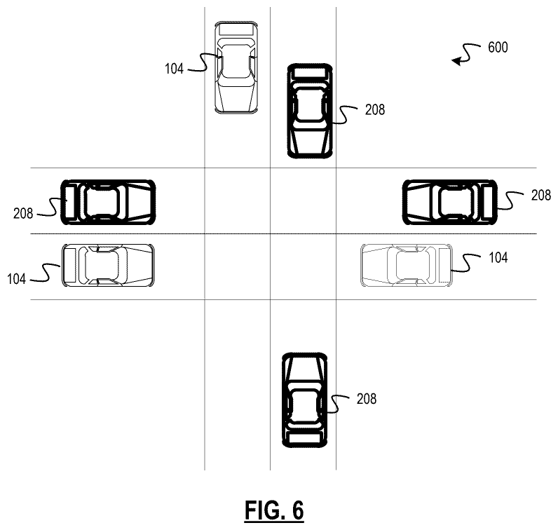

When the ASV services provided to the BSV 104 address coverage of urban intersections and roads, the ASV service network management system 100 selects a dispersed ASV service network configuration. Referring to FIG. 6, an exemplary diagram of a dispersed ASV service network configuration 600 in accordance with at least one embodiment is shown. The formation ASVs 208 are disposed in the dispersed ASV service network configuration 600 to provide coverage of urban intersections and roads ASV services to multiple BSVs 104.

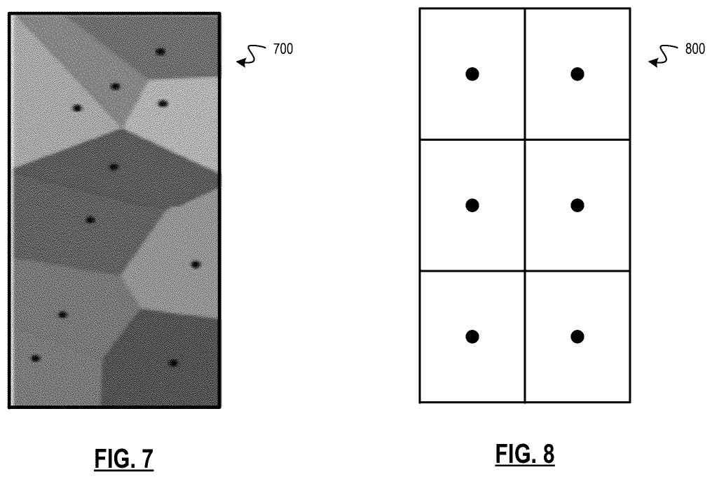

The ASV service network management system 100 determines the ASV formation position for each ASV 208 within the ASV service network configuration by defining the coverage area associated with that ASV service network configuration. In at least one embodiment, the ASV service network management system 100 employs Voronoi partitioning to ensure a uniform distribution of the formation ASVs 208. Referring to FIG. 7, an exemplary diagram of a plurality of ASV formation positions based on Voronoi partitioning 700 in accordance with at least one embodiment is shown. Each partitioned area includes a centroid. Each formation ASV 208 is provided with an ASV formation position that corresponds to a centroid with a Voronoi partitioned area.

In at least one embodiment, the ASV service network management system 100 employs grid-based partitioning to ensure a uniform distribution of the formation ASVs 208. Referring to FIG. 8, an exemplary diagram of a plurality of ASV formation positions based on grid-based partitioning 800 in accordance with at least one embodiment is shown. Each partitioned grid includes a center. Each formation ASV 208 is provided with an ASV formation position that corresponds to a center of a partitioned grid.

Each formation ASV 208 moves to the ASV formation position that the formation ASV received in the ASV service instruction. The ASV formation position of a formation ASV 208 enables the formation ASV 208 to provide ASV services to the BSV 104 from the perspective of the ASV formation position within the ASV service network configuration. The ASV service network configuration enables the formation ASVs 208 in aggregate to provide comprehensive coverage associated with ASV services being provided to the BSV 104. In at least one embodiment, the formation position of each formation ASV 208 is within 150 meters of the BSV 104.

Referring back to FIG. 3, each formation ASV 208 moves into the ASV formation position in accordance with the ASV service instruction received from the ASV service network management system 100. Each formation ASV 208 establishes a communication channel with the BSV 104. Each formation ASV 208 transmits ASV sensor data to the BSV system 106 of the BSV 104. The formation ASVs 208 have a higher level of automation than the BSV 104. The formation ASVs 208 include instrumentation that the BSV 104 does not have. The ASV sensor data generated by the instrumentation of the formation ASVs 208 are transmitted from the formation ASVs 208 to the BSV 104 for use by the BSV 104. In at least one embodiment, an Advanced Driving System (ADS) of the BSV 104 receives the ASV sensor data and uses the ASV sensor data to guide the implementation of ADS operations.

Examples of ASV sensor data include, but are not limited to, perception data, driving behavior events, network data, and services data. Examples of perception data include, but are not limited to, detected objects, lane markings, traffic signs, road surfaces, work zones, and weather conditions. Examples of driving behavior events include, but are not limited to, hard braking, harsh acceleration, and Advanced Driver Assistance System (ADAS) alerts. Examples of network data and service data include, but are not limited to, traffic, traffic signal timing, emergency vehicles, and connected work zone data, such as that provided by the Work Zone Data Exchange (WZDx).

At 308, the ASV service network management system 100 receives BSV data from the BSV 104. Examples of the BSV data include, but are not limited to, Global Positioning System (GPS) time, latitude, longitude, speed, yaw rate, and acceleration. The BSV data is real time BSV data.

At 310, the ASV service network management system 100 generates a predicted BSV path of the BSV 104 based on BSV data received from the BSV 104. In at least one embodiment, the ASV service network management system 100 employs digital maps in conjunction with the BSV data to generate the predicted BSV path. At 312, the ASV service network management system 100 generates a predicted next BSV location based on the predicted BSV path.

At 314, the ASV service network management system 100 generates an updated ASV formation position for each of the formation ASVs 208 based on the predicted next BSV location of the BSV 104. The updated ASV formation positions of the formation ASVs 208 are associated with a dynamic reconfiguration of the ASV service network configuration to accommodate the predicted next BSV location in accordance with the predicted BSV path. At 316, the ASV service network management system 100 transmits the updated ASV formation position for each formation ASV 208 to the formation ASV 208.

Each formation ASV 208 computes an ASV acceleration associated with moving to the associated updated ASV formation position. The ASV acceleration computation takes into account ASV passenger comfort to ensure smooth movement of the formation ASV 208 to the updated ASV formation position. The method 300 returns to 308.

In at least one embodiment, the ASV service network management system 100 is configured to implement a dynamic reconfiguration of the ASV service network configuration associated with a BSV in response to a number of dynamic reconfiguration triggers. Examples of dynamic reconfiguration triggers include, but are not limited to, weather and visibility conditions, natural disaster situations, road construction, situations where additional ASV sensor data is needed to assess a road event, situations where a BSV 104 needs additional navigational assistance, formation breaks where a formation ASV 208 is asked to break away and sent ahead to “scout”, to provide enhanced ASV service support in connection with a BSV diagnostic issue, and a BSV 104 with no sensing capabilities that relies on ASV sensor data in connection with BSV operations.

In at least one embodiment, if a formation ASV 208 needs to exit the ASV service network configuration associated with a BSV 104, the ASV service network management system 100 selects another ASVs 208 within a pre-defined distance of the BSV 104 that is operating below the associated ASV capacity to replace the exiting formation ASV 208.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of managing an advance sensing vehicle (ASV) service network comprising:
receiving, by a controller, an ASV service request from a basic sensing vehicle (BSV), the ASV service request comprising a BSV location;
identifying, by the controller, at least one formation ASV from a list of ASVs within a pre-defined distance of the BSV operating below an ASV capacity to provide ASV services to the BSV, wherein the list of ASVs is maintained at the controller and a level of an automation system of each of the at least one formation ASVs is higher than a level of an automation system of the BSV; and
transmitting, by the controller, an ASV service instruction comprising an ASV formation position to each of the at least one formation ASV, wherein:
a ASV service network configuration is formed with respect to the BSV when each of the at least one formation ASV moves to the ASV formation position received in the associated ASV service instruction,
each of the at least one formation ASV establishes a communication channel with the BSV, and
each of the at least one formation ASV transmits ASV sensor data to the BSV for use by an Advanced Driving System (ADS) of the BSV to implement ADS operations.

2. The method of claim 1, further comprising receiving, by the controller, the ASV service request from the BSV, wherein the ASV service request is automatically generated by the BSV in response to the BSV entering an ASV service area.

3. The method of claim 1, further comprising receiving, by the controller, the ASV service request from the BSV, wherein the ASV service request is generated by the BSV in response to activation of a ASV service request button of the BSV.

4. The method of claim 1, further comprising receiving, by the controller, the ASV service request from the BSV, wherein the ASV service request is automatically generated by the BSV in response to activation of at least one specific function of the BSV.

5. The method of claim 1, further comprising:
defining, by the controller, a coverage area associated with the ASV service network configuration;
partitioning, by the controller, the coverage area into a plurality of partitioned areas using Voronoi partitioning, each of the plurality of partitioned areas in including a centroid; and
transmitting, by the controller, the ASV service instruction comprising the ASV formation position to each of the at least one formation ASV, wherein each ASV formation position is based on the centroid of one of the plurality of partitioned areas.

6. The method of claim 1, further comprising:
defining, by the controller, a coverage area associated with the ASV service network configuration;
partitioning, by the controller, the coverage area into a plurality of partitioned areas using grid-based partitioning, each of the plurality of partitioned areas in including a center; and
transmitting, by the controller, the ASV service instruction comprising the ASV formation position to each of the at least one formation ASV, wherein each ASV formation position comprises the center of a partitioned grid.

7. The method of claim 1, wherein the ASV service network configuration comprises a full-forward ASV service network configuration.

8. The method of claim 1, wherein the ASV service network configuration comprises a distributed ASV service network configuration.

9. The method of claim 1, wherein the ASV service network configuration comprises a dispersed ASV service network configuration.

10. The method of claim 1, wherein the ASV sensor data comprises perception data, driving behavior events, network data, and services data.

11. The method of claim 1, further comprising:
receiving, at the controller, BSV data from the BSV, the BSV data comprising Global Positioning System (GPS) time, latitude, longitude, speed, yaw, and acceleration;
generating, by the controller, a predicted BSV path based on the BSV data;
generating, by the controller, a predicted next BSV location based on the predicted BSV path;
generating updated ASV formation positions for each of the at least one formation ASVs based on the predicted next BSV location, the updated ASV formation positions being associated with a dynamic reconfiguration of the ASV service network configuration to accommodate the predicted next BSV location; and
transmitting the updated ASV formation positions to each of the at least one formation ASVs.

12. An advanced sensing vehicle (ASV) network management system, comprising:
at least one processor; and
at least one memory communicatively coupled to the at least one processor, the at least one memory comprising instructions that upon execution by the at least one processor, causes the at least one processor to:
receive an ASV service request from a basic sensing vehicle (BSV), the ASV service request comprising a BSV location;
identify at least one formation ASV from a list of ASVs within a pre-defined distance of the BSV operating below an ASV capacity to provide ASV services to the BSV, wherein the list of ASVs is maintained at the controller and a level of an automation system of each of the at least one formation ASVs is higher than a level of an automation system of the BSV; and
transmit an ASV service instruction comprising an ASV formation position to each of the at least one formation ASV, wherein:
a ASV service network configuration is formed with respect to the BSV when each of the at least one formation ASV moves to the ASV formation position received in the associated ASV service instruction,
each of the at least one formation ASV establishes a communication channel with the BSV, and
each of the at least one formation ASV transmits ASV sensor data to the BSV for use by an Advanced Driving System (ADS) of the BSV to implement ADS operations.

13. The system of claim 12, wherein the at least one memory further comprises instructions that upon execution by the at least one processor, causes the at least one processor to:
define a coverage area associated with the ASV service network configuration;
partition the coverage area into a plurality of partitioned areas using Voronoi partitioning, each of the plurality of partitioned areas in including a centroid; and
transmit the ASV service instruction comprising the ASV formation position to each of the at least one formation ASV, wherein each ASV formation position is based on the centroid of one of the plurality of partitioned areas.

14. The system of claim 12, wherein the at least one memory further comprises instructions that upon execution by the at least one processor, causes the at least one processor to:
define a coverage area associated with the ASV service network configuration;
partition the coverage area into a plurality of partitioned areas using grid-based partitioning, each of the plurality of partitioned areas in including a center; and
transmit the ASV service instruction comprising the ASV formation position to each of the at least one formation ASV, wherein each ASV formation position comprises the center of a partitioned grid.

15. The system of claim 12, wherein the ASV service network configuration comprises a full-forward ASV service network configuration.

16. The system of claim 12, wherein the ASV service network configuration comprises a distributed ASV service network configuration.

17. The system of claim 12, wherein the ASV service network configuration comprises a dispersed ASV service network configuration.

18. The system of claim 12, wherein the ASV sensor data comprises perception data, driving behavior events, network data, and services data.

19. The system of claim 12, wherein the at least one memory further comprises instructions that upon execution by the at least one processor, causes the at least one processor to:
receive BSV data from the BSV, the BSV data comprising Global Positioning System (GPS) time, latitude, longitude, speed, yaw, and acceleration;
generate a predicted BSV path based on the BSV data;
generate a predicted next BSV location based on the predicted BSV path;
generate updated ASV formation positions for each of the at least one formation ASVs based on the predicted next BSV location, the updated ASV formation positions being associated with a dynamic reconfiguration of the ASV service network configuration to accommodate the predicted next BSV location; and
transmit the updated ASV formation positions to each of the at least one formation ASVs.

20. A cloud based service system including an advanced sensing vehicle (ASV) network management system, comprising:
at least one processor; and
at least one memory communicatively coupled to the at least one processor, the at least one memory comprising instructions that upon execution by the at least one processor, causes the at least one processor to:
receive an ASV service request from a basic sensing vehicle (BSV), the ASV service request comprising a BSV location;
identify at least one formation ASV from a list of ASVs within a pre-defined distance of the BSV operating below an ASV capacity to provide ASV services to the BSV, wherein the list of ASVs is maintained at the controller and a level of an automation system of each of the at least one formation ASVs is higher than a level of an automation system of the BSV;
define a coverage area associated with an ASV service network configuration;
partition the coverage area into a plurality of partitioned areas using Voronoi partitioning, each of the plurality of partitioned areas in including a centroid; and
transmit an ASV service instruction comprising an ASV formation position to each of the at least one formation ASV, each ASV formation position being based on the centroid of one of the plurality of partitioned areas, wherein:
the ASV service network configuration is formed with respect to the BSV when each of the at least one formation ASV moves to the ASV formation position received in the associated ASV service instruction,
each of the at least one formation ASV establishes a communication channel with the BSV, and
each of the at least one formation ASV transmits ASV sensor data to the BSV for use by an Advanced Driving System (ADS) of the BSV to implement ADS operations.
